(19) United States
(12) Patent Application Publication
(10) Pub. No.: US 2023/0286182 A1
(43) Pub. Date: Sep. 14, 2023

(54) ELECTRIC BEARD TRIMMER

(71) Applicant: Braun GmbH, Kronberg (DE)

(72) Inventors: Gerd Laschinski, Bad Homburg (DE); Simone Langwasser, Bad Homburg (DE); Markus Schuessler, Koenigstein (DE)

(21) Appl. No.: 18/119,394

(22) Filed: Mar. 9, 2023

(30) Foreign Application Priority Data
Mar. 10, 2022 (EP) 22161474.6

(51) Int. Cl. B26B 19/38; B26B 19/20

(52) U.S. Cl. CPC B26B 19/3846; B26B 19/20; B26B 19/06

(57) ABSTRACT

The present invention relates to a cutter system for an electric shaver and/or trimmer, comprising a pair of cooperating cutter blades each having at least one row of comb-like cutting teeth, wherein one of said cutter blades is stationary and the other one is movable relative to the stationary cutter blade along a cutting surface defined between said cooperating cutter blades, said cutting teeth each having pairs of lateral cutting edges tapering towards a tooth tip, wherein said tooth tips of at least one of the cooperating cutter blades are provided with a flattened, beveled tip surface.

### FIELD OF THE INVENTION

The present invention relates to cutting body hair such as beard stubbles of multidays' beard. More particularly, the present invention relates to a cutter system for an electric shaver and/or trimmer, comprising a pair of cooperating cutter blades each having at least one row of comb-like cutting teeth, wherein one of said cutter blades is stationary and the other one is movable relative to the stationary cutter blade in a cutting direction along a cutting surface defined between said cooperating cutter blades, said cutting teeth each having pairs of lateral cutting edges tapering towards a tooth tip, wherein a skin contact surface of the cutter system defined by a surface of the stationary cutter blade facing away from the movable cutter blade or a distance comb attached to the stationary cutter blade has an inclined forward end portion for guiding, in the region of the tooth tips, the cutter blades along the skin of a user and defining an acute angle to said cutting surface. Furthermore, the present invention also relates to an electric shaver and/or trimmer including such cutter system.

### BACKGROUND OF THE INVENTION

Electric shavers and trimmers utilize various mechanisms to provide hair cutting functionality. Some electric shavers include a perforated shear foil cooperating with an undercutter movable relative thereto so as to cut hairs entering the perforations in the shear foil. Such shear foil type shavers are often used on a daily basis to provide for a clean shave wherein short beard stubbles are cut immediately at the skin surface.

On the other hand, other cutter systems including a pair of cooperating comb-like cutting elements with a plurality of comb-like or rake-like cutting teeth reciprocating or rotating relative to each other, are often used for cutting longer beard stubbles or problem hair that is difficult to cut due to, for example, a very small angle to the skin or growing from very resilient skin. The teeth of such comb-like or rake-like cutting elements usually project substantially parallel to each other or substantially radially, depending on the type of driving motion, and may cut hairs entering into the gaps between the cutting teeth, wherein cutting or shearing is achieved in a scissor-like way when the cutting teeth of the cooperating elements close the gap between the finger-like cutting teeth and pass over each other.

Such cutter systems for longer hairs may be integrated into electric shavers or trimmers which at the same time may be provided with the aforementioned shear foil cutters. For example, the comb-like cutting elements may be arranged between a pair of shear foil cutters or may be arranged at a separate, extendable long hair cutter. On the other hand, there are also electric shavers or trimmers or styling apparatus which are provided only with such comb-like cutting elements.

For example, EP 24 25 938 B1 shows a shaver with a pair of long hair trimmers integrated between shear foil cutters. Furthermore, CN 206 287 174 U discloses a beard trimmer having a pair of cooperating comb-like cutting elements each of which is provided with two rows of projecting cutting teeth.

Moreover, EP 3 003 654 B1 discloses a hair clipping device with a pair of cooperating cutting blades having comb-like cutting teeth, wherein the stationary cutter blade forming the skin contact surface of the cutter system should have lateral cutting edges with a wedge-shaped cross section defining a wedge angle of less than 55°, wherein the finger-like cutting teeth should taper towards the tooth tip at an opening angle or scissor angle ranging from 5° to 25°.

US-A-20160229070 discloses a moveable blade of a hair trimmer having a flattened, beveled portion close to the tooth tip at a tooth height level remote from the cutting surface. The tooth tip is provided with a non-beveled but vertical area which extends perpendicular to a cutting surface of the moveable blade.

WO-A1-2018109093 discloses a moveable blade of a hair trimmer having a flattened, beveled tooth tip.

Such beard stubble trimmers need to address quite different and diverging functional requirements and performance issues such as closeness, thoroughness, good visibility of the cutting location, efficiency and pleasant skin feel, good ergonomics and handling. Closeness means short or very short remaining stubbles, whereas thoroughness means less missed hairs particularly in problem areas like the neck. Efficiency means less and faster strokes suffice to achieve the desired trimming result. Pleasant skin feel depends on the individual user, but often includes less irritation in form of nicks, cuts or abrasion and better gliding onto the skin.

So as to achieve smooth and efficient cutting, hairs should be cut at the first contact with the cutter blades when entering into the gaps between the finger-like teeth. However, such first contact cut is difficult to achieve due to the scissor-like, shearing-type cutting action of comb-like cutter blades, since hairs are not cut by touching the cutting edge of one cutter blade only, but by getting caught between the cutting edges of cooperating cutting teeth, i.e. at the shearing point or contact point where the cutting edge of one cutter blade slides over the cutting edge of the other cutter blade.

Conventional cutter systems show a tendency to deflect and reject hairs a couple of times before indeed cutting them. The teeth of the movable cutter blade bump into the hairs and kick them away before they get caught between the lateral cutting edges sliding over each other. Due to such bumping action of the cutting teeth, hairs are sort of “dancing” in terms of elastically shaking and deflecting snake-like before getting cut.

Such dancing of the hairs can be found particularly at the entrance of the gaps between the finger-like cutting teeth. Usually, the traveling speed of the cutter system along the skin surface—depending on the user's preferences of manually moving the trimmer along the skin—is usually low in comparison to the cutting speed of the cutter blades transverse to the traveling direction, so a major share of the cutting action occurs at the forward end portions of the cutting teeth close to the tips thereof. As traveling speed is low in comparison to cutting speed, the cutting teeth of the driven cutter blade bump into the hairs entering into the gaps between the finger-like cutting teeth mainly transverse, i.e. with a major moving component in the cutting direction transverse to the traveling direction of the cutter system. Thus, when viewing the cutting scene in the direction of traveling of the cutter-system, hairs are dancing from left to right before getting cut. Due to such dancing, hairs contact the moving teeth of the driven cutter blade a plurality of times before indeed getting to the shearing point where neighboring cutting edges pass over each other to cut the hair.

One issue that makes first contact cutting difficult, is the growing direction of hair which usually is not perpendicular to the skin surface, but the hair grows out of the skin at an acute angle and thus, tends to collide with the protruding cutting teeth before having reached the shearing point where cooperating teeth pass over each other. More particularly, the inclined or oblique hair may be pushed away by the upper contours of the cutting teeth spaced apart from the cutting plane and thus, does not get directly and smoothly to the shearing point where the cutting edges of two cooperating teeth start to overlap each other and cut the hair in a scissor-like shearing action.

Trimmer operates on the principle of scissor cutting, where two comparatively blunt blades such as a stationary blade and moveable blade work against each other and shear off the hairs being in between. Comparatively blunt means that one blade alone is not sharp enough to cut the hairs. Cutting, or rather shearing, takes place because the blades run against each other and act as counter-blades. Cutting takes place in the cutting area or shearing area where the surfaces of the two blades touch and move towards each other so only the cutting edge directly at the cutting plane may affect cutting, whereas more elevated portions of the cutting teeth in terms of spaced apart from the cutting plane effect rejecting rather than cutting the hairs. Typically, the movable blade may be driven by a motor to an oscillating lateral/transverse movement, wherein the speed of the moveable blade is typically high compared to the manual movement of the trimmer across the skin.

Both the stationary blade and the movable blade have a plurality of teeth on the front. The sides of the teeth are formed as cutting edges. The movable blade is typically set back from the stationary blade to avoid skin injuries.

When the trimmer is moved over the skin, the hairs are first threaded between the teeth of the stationary blade. The cutting edge of the stationary blade is relatively blunt and therefore does not cut the hair by itself. Rather, the hairs are guided towards the movable blade. When the hairs come into the area of the moveable blade, they can be first touched by the tip of the moveable blade. As the tip of the moveable blade also has a material thickness above the cutting area, the hairs may be pushed away without cutting them immediately. The thickness of material at the tip of the teeth above the cutting surface does not contribute to cutting but reduces efficiency by pushing away hairs.

This occurs especially when the hairs are inclined towards the moveable blade. This is very common and there are two reasons for this. Firstly, most hairs grow out of the skin at an acute angle significantly different from 90°. And secondly, for good efficiency, the trimmer is usually held at an angle to the skin so that the tips of the stationary blade get under the inclined hairs, lift them, and then feed them to the cutting system. Such inclined positioning of the cutter system with the tooth tips tilted downwards to the skin, is facilitated and to some extent guided, by an inclined forward end portion of the skin contact surface at the bottom of the cutter system which forward end portion may be tilted to the cutting plane defined between the cutter blades at an acute angle thereto. Therefore, a certain portion of hairs are inclined towards the moveable blade and thus, may be kicked away by the moving blade even more easily.

Fulfilling the aforementioned various performance issues at the same time is quite difficult. For example, EP 3 003 654 B1 aims at an efficient cutting action with a rather low contact pressure between the cutter blades, however, tends to leave a non-uniform cut length and to create plucking and picking due to pushing away the hairs when moving the cutter system along the skin surface. Cutting efficiency is detrimentally affected by the aforementioned problem of the movable cutter blade bumping into the hairs and kicking them away what cannot be avoided by the specific structure of the stationary blade suggested by this document. Consequently, no first contact cutting can be achieved.

### SUMMARY OF THE INVENTION

It is an objective underlying the present invention to provide for an improved cutter system avoiding at least one of the disadvantages of the prior art and/or further developing the existing solutions. A more particular objective underlying the invention is to provide for a highly efficient and, at the same time, reliable and clean cutting action of the cooperating cutting teeth, even when moving the cutter system in fast strokes along the skin contour, without sacrificing a smooth and comfortable cutting action.

A still further objective underlying the invention is to achieve first contact cutting without dancing of the hairs at the entrance portion of the gaps between neighboring cutting teeth.

At least one of these objectives is achieved by the features of claims 1, 17 and 18.

Further advantageous features are set forth by the sub-claims.

To achieve at least one of the aforementioned objectives, it is suggested to give the tooth tips of the cutting teeth a configuration not pushing away or less pushing away hair entering into the gaps between the comb-like teeth and allowing the hair to quickly find the cutting position between cooperating cutting edges. More particularly, the beveled tip surface of the tooth tips of at least the movable cutter blade is inclined, at an acute angle, to a virtual plane extending parallel to the cutting direction and perpendicular to the forward end portion of the skin contact surface of the cutter system and/or to a tangential plane tangential thereto so the tooth tip touches the virtual plane only at the cutting surface with a substantially wedge-shaped void between the flattened beveled tip surface and the virtual plane. The bevels at the tips of the teeth remove sufficient material at the tip portions that could be responsible for pushing hairs out so especially hairs grown out of the skin at an acute angle and thus inclined towards the cutter system, are less likely to be touched and less likely to be pushed out by the tooth tips. At first sight it is somewhat surprising that kicking away the hairs and dancing thereof can be reduced by giving the tooth tips a specific configuration relative to the skin contact surface of the cutter system, as one would suppose, in view of the high transverse cutting speed, it is the lateral side of the teeth that is responsible for kicking away the hairs. However, inclining the tooth tips backwards reduces tooth height at the forward ends thereof and sort of sharpens the lateral cutting edges at their foremost end portions so hairs, even when growing obliquely, have a reduced tendency to touch elevated portions of the teeth before getting into contact with the cutting edge directly at the cutting surface. The foremost or outermost end portion of the lateral cutting edge becomes more effective and first contact cutting there becomes more likely what is quite helpful in reducing dancing of the hairs as a major portion of the cutting action occurs at the entrance of the gaps between neighboring teeth due to the cutting speed being rather high in comparison to forward traveling of the cutter system. The above tooth tip design means that the foremost tooth tip of the cutting teeth of the moveable cutter blade has substantially no vertical plane area orthogonal to the cutting surface (plane) or that such a vertical extension at the foremost tip is smaller than the diameter of a hair (0.1 mm), so that both the tooth tip and the above-mentioned wedge-shaped void are sharp and extend until the cutting surface. In other words, the flattened, beveled tip surface extends to the cutting surface of the cutting teeth.

More particularly, the tooth tip surface is inclined away from the hairs in front of the cutter blades, i.e. the tooth tip surface is inclined rearwardly towards the root portion of the teeth, so hairs entering into the comb-like teeth rows, even when growing obliquely or inclined out of the skin, are less likely kicked away by the tip portion of the cutting teeth and more likely to get cut at first contact with the cutting teeth.

More particularly, since such flattened, beveled tooth tip surfaces are provided to the cutting teeth of at least the movable cutter blade, dancing of the hairs can be significantly reduced because pushing away hairs is mainly caused by the reciprocating or moving cutting teeth of the movable cutter blade which are moving into and out of the gaps between the teeth of the stationary cutter blade. Due to the inclination of the tip surfaces backwards, it is less likely that hairs bump into the tip surface before getting sheared between the cutting edges of the cooperating blades.

So as to achieve first contact cutting without dancing of the hairs and, at the same time, to have sufficient structural stability of the teeth, said acute angle of inclination of the flattened beveled tip surface to the aforementioned virtual plane may range from 10° to 40° or 10° to 20°.

The flattened, beveled tooth tips may have a substantially planar tip surface, wherein in such case the void between the tooth tips and the aforementioned virtual plane may be indeed wedge-shaped. However, the tip surface, still having a flat configuration, may not be exactly planar, but may include some curvature such as slightly convex or concave portions, or some rounding or non-planar portions so the substantially wedge-shaped void may be deemed to be defined between said virtual plane and a tangential plane which is tangential to said tip surface. In other words, the wedge defining the void does not need to have two planar sides. More particular, the wedge-like void, at its side facing the tooth tip, may have a wedge surface which is not exactly planar.

More particularly, the tooth tips of the movable cutter blade, in cross-sectional planes parallel to the cutting surface, may define linear contours parallel to the cutting direction so hairs contacting the tip surface may smoothly slide along the tooth tip surface without being subject to bumping forces due to the transverse cutting movements. Due to lack of convex or concave contours when viewed in cross-sectional planes parallel to the cutting surface, the tooth tip surfaces do not effect wedge-like rejection forces onto the hairs even when reciprocating at high speed in the cutting direction, but the tooth tip surfaces of the moving cutting teeth may just smoothly slide along hairs contacting the tip surface.

More particularly, the cutting teeth, at the tooth tips, may define a pyramid-like contour with three inclined, planar surfaces joining each other, one of said inclines, planar surfaces being formed by the flattened, beveled tip surface and the other two inclined, planar surfaces being formed by the lateral cutting edges of the cutting tooth. Such pyramid-like contour may be a sort of partial pyramid and is no complete pyramid as it has only three flattened, inclined surfaces and lacks the fourth side of a pyramid and furthermore, it does not have a rectangular basis like a regular pyramid, but nevertheless it is sort of similar to a part of a pyramid having three flattened side surfaces inclined relative to each other and inclined relative to the basis

To further help hairs getting cut at first contact with the teeth, the flattened beveled tip surface may be substantially planar with an angular transition to the lateral cutting edges of the cutting teeth, said angular transition having a radius of curvature of less than 50 μm or less than 25 μm or less than 10 μm. Such edgy transition from the tip surface to the lateral cutting edges gets hairs passing the tooth tip more or less immediately onto the lateral cutting edge and avoids pushing away hairs as it would be the case with rounded transitions from the lateral cutting edges to the tip portions at rather large radii of curvature.

Hairs which have passed the tooth tips and entered into the gap between a pair of neighboring cutting teeth are basically ready to be cut or sheared by the lateral cutting edges of a pair of cooperating cutting teeth. Although having passed the, so to say, first hurdle in terms of the tooth tips, the hair still might be rejected or pushed out of the gap again when contacting the lateral cutting edges. Usually, the lateral cutting edges do not extend exactly perpendicular to the moving direction of the teeth, but are inclined thereto, wherein usually the teeth are tapering towards the tooth tips so as to avoid cutting all hairs between a pair of cooperating teeth exactly at the same time. Due to the tapered configuration of the teeth, overlapping of the lateral cutting edges starts at the inner end portion or root portion of the teeth and continuously moves outwardly towards the tooth tips due to such tapered configuration when cooperating teeth are driven transversely relative to each other. Thus, a smooth cutting action can be achieved by means of such tapered configuration. On the other hand, however, due to such tapered configuration, the forces applied onto a hair by the contacting lateral cutting edges include a component directed outwardly, i.e. from the bottom portion of the gap between cooperating teeth to the open end of said gap, thereby creating the tendency of deflecting the hair outwardly and/or pushing away the hair towards the tooth tips. The more tapering, the stronger the tendency of pushing hairs outwardly.

So as to address such issue, the opening angle between neighboring teeth and/or the tapering of the teeth could be kept small or even set zero, but this would create high cutting forces which could cause the system to block or the blades to lift off.

So as to allow some tapering of the teeth and an opening angle sufficiently large to keep cutting forces small, but nevertheless avoid the aforementioned problem of pushing hairs back outwardly towards the tooth tips, it is suggested according to another aspect to make the lateral cutting edges rather sharp to reduce the tendency of deflecting hairs towards the tooth tips. More particularly, the lateral cutting edges of the cutting teeth, when viewed in a cross-section taken perpendicular to a longitudinal axis of a respective tooth, may have a wedge-like configuration with a wedge angle smaller than 60° or smaller than 50° or ranging from 35° to 60° or from 45° to 50°.

So as to avoid pushing back hairs at the tooth tips and at the lateral cutting edges, the sum of the aforementioned tip angle (between the beveled tip surface and the cutting surface between the cutting blades) and the wedge angle of the lateral cutting edges may be less than 110° or may range from 60° to 110° or from 90° to 110°.

The opening angle of a gap between two neighboring teeth as defined by the lateral cutting edges of said neighboring teeth facing each other, may range from 10° to 30° to combine smooth cutting with keeping the hairs in the gap. More particularly, said opening angle may range from 15° to 25°.

Said opening angle may be chosen differently for different wedge angles. For example, the larger the opening angle, the smaller the wedge angle. More particularly, the sum of the wedge angle and the opening angle may be smaller than 80° or smaller than 75° or smaller than 70°.

The above objective is also achieved by a cutter system for an electric shaver and/or trimmer, comprising a pair of cooperating cutter blades each having at least one row of comb-like cutting teeth, wherein one of said cutter blades is a stationary cutter blade and the other one of said cutter blades is a movable cutter blade movable relative to said stationary cutter blade in a cutting direction along a cutting surface defined between said cooperating cutter blades, said cutting teeth each having pairs of lateral cutting edges tapering towards a tooth tip, wherein the tooth tips of at least the movable cutter blade are provided with a flattened, beveled tip surface wherein the flattened, beveled tip surface extends to the cutting surface of the cutting teeth with a tip angle (β) between the flattened, beveled tip surface and the cutting surface ranging from 30° to 70° or 50° to 65°, wherein said lateral cutting edges, when considering a cross sectional view transverse to a longitudinal tooth axis of the respective cutting tooth, have a wedge-shaped configuration with a wedge angle (γ) ranging from 35° to 60° or 40° to 55° or 45° to 50° and wherein a sum of the tip angle (β) and the wedge angle (γ) is less than 120° or less than 110°, and/or ranges from 90° to 120° or from 100° to 110°. This cutter system may be combined with any feature of the subclaims

These and other advantages become more apparent from the following description giving reference to the drawings and possible examples.

### BRIEF DESCRIPTION OF THE DRAWINGS

FIG. 1: a perspective view of an electric beard trimmer including a cutter system with a pair of cooperating comb-like cutter blades reciprocating relative to each other,

FIG. 2: a side view of the beard trimmer of FIG. 1 showing the inclined skin contact surface of the cutter blades at a forward end portion thereof,

FIG. 3:

a cross sectional view of the beard trimmer of FIGS. 1 and 2 showing the drive mechanism for the cutter system,

FIG. 4: a perspective view of the cutter system of the trimmer of the preceding figures, wherein a movable support structure for supporting a movable cutter blade movably relative to a stationary cutter blade and a spring mechanism for urging the movable cutter blade onto the stationary cutter blade, are shown,

FIG. 5: a longitudinal sectional view of the cutter system of FIG. 4 showing the movable and stationary cutter blades positioned onto each other,

FIG. 6: a sectional side view of the cutter system similar to FIG. 5, wherein the cutter system is shown in a tilted position with a skin contact surface of the stationary cutter blade touching the skin and a hair growing out of the skin at an acute angle, wherein lack of contact of the hair to the tooth tip of the movable cutter blade due to the beveled tooth tip thereof is illustrated,

FIG. 7: a sectional side view of a cutter system similar to FIG. 6, wherein the tooth tip of the movable cutter blade lacks beveling of the tip surface and therefore pushes away the obliquely grown hair,

FIG. 8: a sectional side view of the cutter system of FIG. 7 illustrating that the inclined hair is pushed away even when the cutter system is tilted less steeply,

FIG. 9a-9c: views of the movable cutter blade, wherein partial view FIG. 9a is a perspective view of the entire movable cutter blade with its row of comb-like teeth and partial view FIG. 9b is a partial plane view of a couple of cutting teeth illustrating the opening angle defined between a pair of neighboring teeth, and partial view FIG. 9c is a bottom view of a cutting tooth showing the non-rounded transition from the lateral cutting edges to the tip,

FIG. 10: a partial plane view of three teeth of the movable cutter blade illustrating the flattened beveled tip surface and the wedge-like lateral cutting edges of the teeth,

FIG. 11: a longitudinal cross-sectional view of a tooth taken along line A-A in FIG. 10 to show the tip angle between the tooth tip surface and the cutting surface,

FIG. 12: a transverse sectional view taken along line B-B in FIG. 10 to illustrate the wedge-like configuration of the lateral cutting edges and the wedge angle thereof,

FIG. 13: sectional views of possible tooth tip configurations illustrating the tip angle,

FIG. 14: a cross-sectional view of a cutting tooth illustrating the wedged configuration of the lateral cutting edges,

FIG. 15: a sectional side view of the cutter system with a distance comb attached thereto, wherein the cutter system is shown with the distance comb touching the skin surface and the tip angle relative to the skin contact surface defined by the distance comb, and,

FIG. 16: a sectional side view of the cutter system similar to FIG. 15 but without views of a distance comb.

### DETAILED DESCRIPTION OF THE INVENTION

So as to get the hairs smoothly into the cutting zone, it is suggested to give the tooth tips of the cutting teeth a configuration not pushing away or less pushing away hair entering into the gaps between the comb-like teeth and allowing the hair to quickly find the cutting position between cooperating cutting edges.

More particularly, the beveled tip surface of the tooth tips of the movable cutter blade is inclined, at an acute angle, to a virtual plane extending parallel to the cutting direction or reciprocating direction of the movable cutter blade, and perpendicular to the forward end portion of the skin contact surface of the cutter system and/or to a tangential plane tangential thereto so the tooth tip touches the virtual plane only at the cutting surface with a substantially wedge-shaped void between the flattened beveled tip surface and the virtual plane. The bevels at the tips of the teeth remove sufficient material at the tip portions that could be responsible for pushing hairs out so especially hairs grown out of the skin at an acute angle and thus inclined towards the cutter system, are less likely to be touched and less likely to be pushed out by the tooth tips. At first sight it is somewhat surprising that kicking away the hairs and dancing thereof can be reduced by giving the tooth tips a specific configuration relative to the skin contact surface of the cutter system, as one would suppose, in view of the high transverse cutting speed, it is the lateral side of the teeth that is responsible for kicking away the hairs. However, inclining the tooth tips backwards reduces tooth height at the forward ends thereof and sort of sharpens the lateral cutting edges at their foremost end portions so hairs, even when growing obliquely, have a reduced tendency to touch elevated portions of the teeth before getting into contact with the cutting edge directly at the cutting surface. The foremost or outermost end portion of the lateral cutting edge becomes more effective and first contact cutting there becomes more likely what is quite helpful in reducing dancing of the hairs as a major portion of the cutting action occurs at the entrance of the gaps between neighboring teeth due to the cutting speed being rather high in comparison to forward traveling of the cutter system. This means that the foremost tooth tip of the cutting teeth of the moveable cutter blade has substantially no vertical plane area which would be orthogonal to the cutting surface (plane) or that such a vertical extension is smaller than the diameter of a hair, so both the tooth tip and the above-mentioned wedge-shaped void are sharp and extend until the cutting surface. In other words, the flattened, beveled tip surface extends to the cutting surface of the cutting teeth.

More particularly, the tooth tip surface is inclined away from the hairs in front of the cutter blades, i.e. the tooth tip surface is inclined rearwardly towards the root portion of the teeth and/or backwards when considering the advancing direction of the cutter system, so hairs entering into the comb-like teeth rows, even when growing obliquely or inclined out of the skin, are less likely kicked away by the tip portion of the cutting teeth and more likely to get cut at first contact with the cutting teeth.

So as to achieve first contact cutting without dancing of the hairs and, at the same time, to have sufficient structural stability of the teeth, said acute angle of inclination of the flattened beveled tip surface to the aforementioned virtual plane may range from 10° to 40° or 10° to 20°.

Said tooth tips, in cross-sectional planes parallel to the cutting surface, may define linear contours parallel to the cutting direction so hairs contacting the tip surface may smoothly slide along the tooth tip surface without being subject to bumping forces due to the transverse cutting movements. Due to lack of convex or concave contours—when viewed in cross-sectional planes parallel to the cutting surface, the tooth tip surfaces do not effect wedge-like rejection forces onto the hairs even when reciprocating at high speed in the cutting direction, but the tooth tip surfaces of the moving cutting teeth may just smoothly slide along hairs contacting the tip surface.

More particularly, the cutting teeth, at the tooth tips, may define a pyramid-like contour with three inclined, planar surfaces joining each other, one of said inclines, planar surfaces being formed by the flattened, beveled tip surface and the other two inclined, planar surfaces being formed by the lateral cutting edges of the cutting tooth.

More particularly, the tooth tips of at least one of the cooperating cutter blades may be provided with a flattened, beveled tip surface with a tip angle, between said flattened beveled tip surface and the cutting surface which is defined between said cooperating cutter blades, ranging from 30° to 70° or 55° to 65°.

Such beveling of the tooth tips helps to reduce pushing out or deflecting hairs trying to enter the gap between neighboring cutting teeth. The bevels at the tips of the teeth remove material at the tip portions that could be responsible for pushing hairs out so especially hairs grown out of the skin at an acute angle and thus inclined towards the cutter system moving forward along the skin contour, are less likely to be touched and less likely to be pushed out.

More particularly, such flattened, beveled tooth tip surfaces may be provided to the cutting teeth of the movable cutter blade to avoid pushing away hairs by the reciprocating or moving cutting teeth which are moving into and out of the gaps between the teeth of the stationary cutter blade.

To further help hairs getting cut at first contact with the cutting teeth, the flattened beveled tip surface may be substantially planar with an angular transition to the lateral cutting edges of the cutting teeth, said angular transition having a radius of curvature of less than 50 μm or less than 35 μm or less than 25 μm or even smaller. Such edgy transition from the tip surface to the lateral cutting edges gets hairs passing the tooth tip more or less immediately onto the lateral cutting edge and avoids pushing away hairs as it would be the case with rounded transitions from the lateral cutting edges to the tip portions at rather large radii of curvature.

Hairs which have passed the tooth tips and entered into the gap between a pair of neighboring cutting teeth are basically ready to be cut or sheared by the lateral cutting edges of a pair of cooperating cutting teeth. Although having passed the tooth tips, the hair still might be rejected or pushed out of the gap again when contacting the lateral cutting edges. Usually, the lateral cutting edges do not extend exactly perpendicular to the moving direction of the teeth, but are inclined thereto, wherein usually the teeth are tapering towards the tooth tips so as to avoid cutting all hairs between a pair of cooperating teeth exactly at the same time. Due to the tapered configuration of the teeth, overlapping of the lateral cutting edges starts at the inner end portion or route portion of the teeth and continuously moves outwardly towards the tooth tips due to such tapered configuration when cooperating teeth are driven transversely relative to each other. Thus a smooth cutting action can be achieved by means of such tapered configuration. On the other hand, however, due to such tapered configuration, the forces applied onto a hair by the contacting lateral cutting edges include a component directed outwardly, i.e. from the bottom portion of the gap between cooperating teeth to the open end of said gap, thereby creating the tendency of deflecting the hair outwardly and/or pushing away the hair towards the tooth tips. The more tapering, the stronger the tendency of pushing hairs outwardly.

So as to address such issue, the opening angle between neighboring teeth and/or the tapering of the teeth could be kept small, but this would create high cutting forces which could cause the system to block or the blades to lift off.

So as to allow some tapering of the teeth and an opening angle sufficiently large to keep cutting forces small, but nevertheless avoid the aforementioned problem of pushing hairs back outwardly towards the tooth tips, it is suggested according to another aspect to make the lateral cutting edges rather sharp to reduce the tendency of deflecting hairs towards the tooth tips. More particularly, the lateral cutting edges of the cutting teeth, when viewed in a cross-section taken perpendicular to a longitudinal axis of a respective tooth, may have a wedge-like configuration with a wedge angle smaller than 60° or smaller than 50° or ranging from 35° to 60° or from 45° to 50°.

So as to avoid pushing back hairs at the tooth tips and at the lateral cutting edges, the sum of the aforementioned tip angle (between the beveled tip surface and the cutting surface between the cutting blades) and the wedge angle of the lateral cutting edges may be less than 110° or may range from 60° to 110° or from 90° to 110°.

The opening angle of a gap between two neighboring teeth as defined by the lateral cutting edges of said neighboring teeth facing each other, may range from 10° to 30° to combine smooth cutting with keeping the hairs in the gap. More particularly, said opening angle may range from 15° to 25°.

Said opening angle may be chosen differently for different wedge angles. For example, the larger the opening angle, the smaller the wedge angle. More particularly, the sum of the wedge angle and the opening angle may be smaller than 80° or smaller than 75° or smaller than 70°. Such wedge angle configuration may be given to the stationary blade and/or to the movable blade, wherein it is particularly advantageous for the movable blade to avoid the problem of kicking hairs away which is mainly caused by the movable blade.

In order to further aid the cutter blades in cutting the hairs in first contact, the cutting teeth may have a rather small tooth width at their tip portions. More particularly, the cutting teeth may have a tip width ranging from ⅙ to ⅔ or ⅙ to ⅓ of a rear width of the cutting teeth at a rear end of the lateral cutting edges which may extend from the rear end to the tooth tip along a straight line. Said tip width may be measured at the forward end of a tooth at a cutting plane which is defined between the stationary and movable blades and along which the movable blade reciprocates relative to the stationary blade.

Basically, the tip width of the cutting teeth may be adjusted to the pitch of the comb-like teeth arrangement. More particularly, said tip width may range from about 1/9 to ⅓ of the toothing pitch, i.e. the distance from tooth to tooth or more particularly, from the center of a tooth to the center of a next tooth. For example, the cutting teeth may have a tip width ranging from ⅙ to ¼ of the pitch.

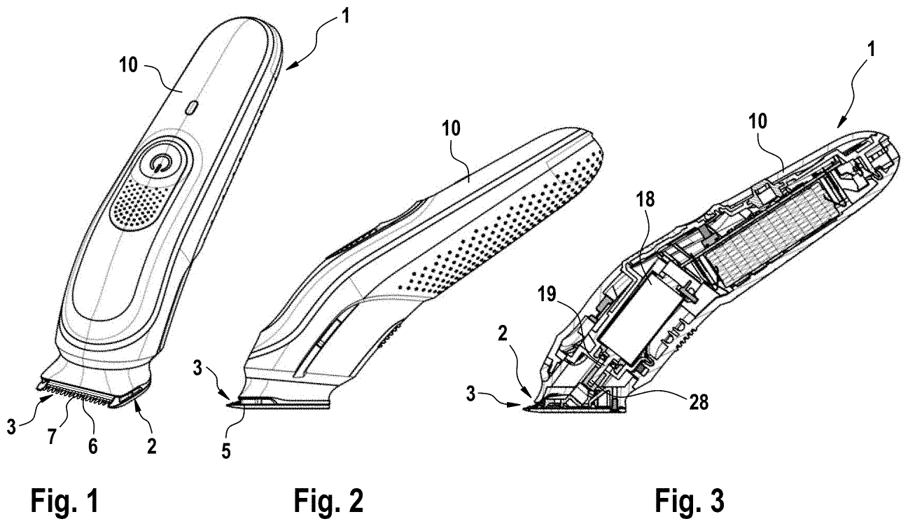

As can be seen from FIGS. 1 to 3, the cutter system 3 may be part of a cutter head 2 which may be attached to a handle 10 of a shaver and/or trimmer 1. More particularly, the shaver and/or trimmer 1 may include an elongated handle 10 accommodating the electronic and/or electric components such as a control unit, an electric drive motor 18 or a magnetic drive motor and a drive train 19 for transmitting the driving action of the motor 18 to the cutter system 3 at the cutter head 2 which cutter head 2 may be positioned at one end of the elongated handle 10, cf. FIG. 1, FIG. 2 and FIG. 3.

The cutter system 3 including a pair of cooperating cutter blades 4 and 5 may be the only cutter system of the cutter head 2 as it is the case with the example shown in FIG. 1. On the other hand, the cutter system 3 may be incorporated into a shaver head 2 having other cutter systems such as shear foil cutters as it is shown in FIG. 12, wherein, for example, the cutter system 3 having at least one row of cooperating cutting teeth 6, 7 may be positioned between a pair of shear foil cutters.

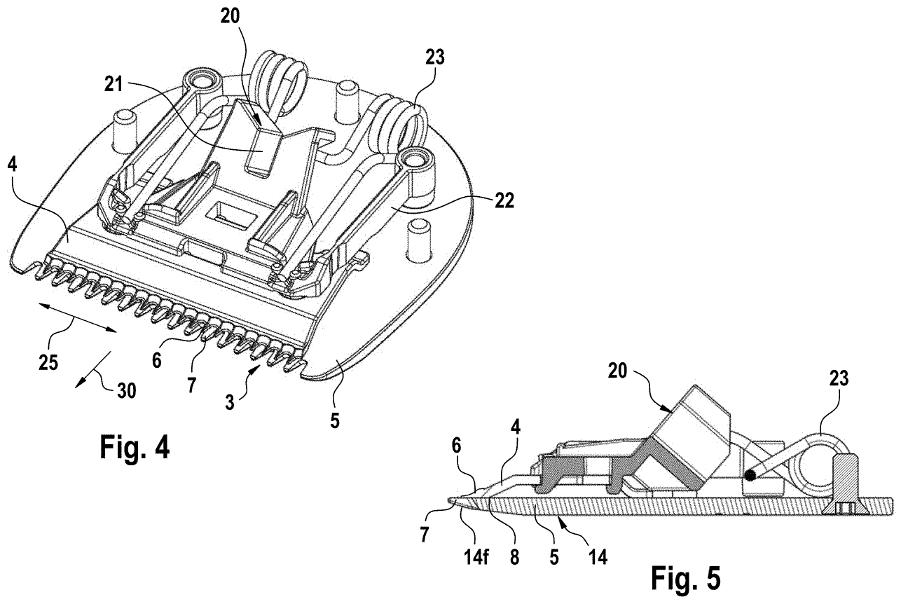

As shown by FIGS. 1 and 4, the cutter system 3 may include elongated rows of cutting teeth 6 and 7 which may reciprocate relative to each other along a linear path so as to effect the cutting action by closing the gaps between the teeth 6, 7 and passing over each other. On the other hand, the cutter system 3 also may include cutting teeth which are aligned along a circle and/or are arranged radially. Such rotatory cutting elements may have cutting teeth projecting substantially radially, wherein the cutting elements may be driven to rotate relative to each other and/or to rotatorily oscillate relative to each other. The cutting action is basically similar to reciprocating cutting elements as the radially extending teeth, when rotating and/or rotatorily oscillating, cyclically close and reopen the gap between neighboring teeth and pass over each other like a scissor.

As shown by FIG. 3 and FIG. 4, the drive system may include a motor 18 the shaft of which may rotate an eccentric drive pin 28 which is received between the channel-like contours 21 of a driver 20 which is connected to one of the cutter blades 4 which is caused to reciprocate due to the engagement of the rotating eccentric drive pin with the contours of said driver, cf. FIG. 4.

As shown by FIGS. 4 to 6, the cooperating cutter blades 4 and 5 basically may have—at least roughly—a plate-shaped configuration, wherein each cutter blade 4 and 5 includes at least one row of cutting teeth 6 and 7, cf. FIG. 4. The cutter blades 4 and 5 are supported and positioned with their flat sides lying onto one another. More particularly, the cutting teeth 6 and 7 of the cutter blades 4 and 5 touch each other back-to-back like the blades of a scissor.

So as to support the cutter blades 4 and 5 in said position relative to each other, but still allowing reciprocating movement of the teeth 6, 7 relative to each other, the cutter blade 4 may be sandwiched between the other cutter blade 5 and a support structure which may include a frame-like or plate-like support.

More particularly, as can be seen from FIGS. 4 and 5, the cutter blades 4, 5 of the cutter system 3 each may have a substantially plate-shaped configuration and/or may be positioned onto one another so that the rows of cutting teeth 6, 7 are in line with each other.

Cutter blade 5 may be a stationary cutter blade which nevertheless may be supported in a sort of self-adjusting way at the handle 10 to allow for adaption to the skin contour. For example, the stationary cutter blade 5—and also the movable cutter blade 4—may swivel and/or tilt relative to the handle 10. However, in the alternative, the stationary cutter blade 5 also may be fixedly attached to the handle 10.

The movable cutter blade 4 is driven by motor 18 via drive train 19, cf. FIG. 3 to reciprocate relative to the stationary cutter blade 5, thereby defining cutting direction 25. For example, the movable cutter blade 4 may be connected to a transmitter 20, wherein a reciprocating or rotating drive pin may be received in a slot-like receiver 21, cf. FIG. 4.

The movable cutter blade 4 may be movably supported by a support structure 22 to move relative to stationary cutter blade 5 such that the teeth 6 of movable cutter blade 4 may reciprocate relative to the cutting teeth 7 of stationary cutter blade 5 so that the cutting teeth 7 repeatedly engage with each other and disengage with each other. A spring mechanism 23 may urge the stationary cutter blade 4 onto the stationary cutter blade 5 to bias the cutter blades 4, 5 onto each other, in particular in the region of the cooperating rows of cutting teeth 6, 7, cf. FIGS. 4 and 5.

The stationary cutter blade 5 may define a skin contact surface 14 at a forward end portion of the cutter system 3, when considering an advancing direction 30 of the cutter system 3. Said contact surface 14 may be defined under and/or at the rows of cutting teeth 6, 7, wherein a bottom side of the cutter blade 5 facing away from the other cutter blade 4, may define said skin contact surface 14, cf. FIG. 16. On the other hand, when a distance comb 15 is attached to the bottom side of the stationary cutter blade 5, it is not the stationary cutter blade 5 itself, but such distance comb 15 which defines the skin contact surface 14 of the cutter system, cf. FIG. 15. More particularly, the surface of the distance comb 15 facing away from the cutter blades 4, 5 may define the skin contact surface 14, cf. FIG. 15.

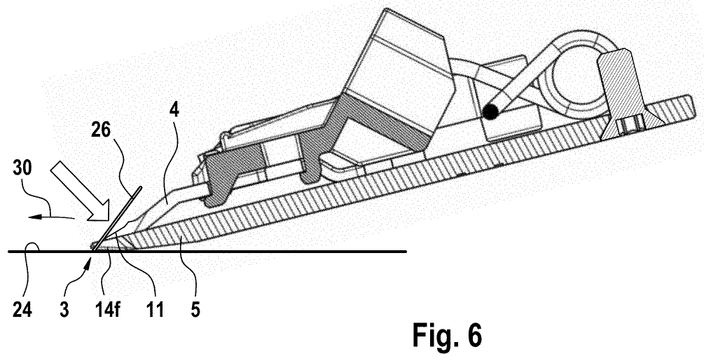

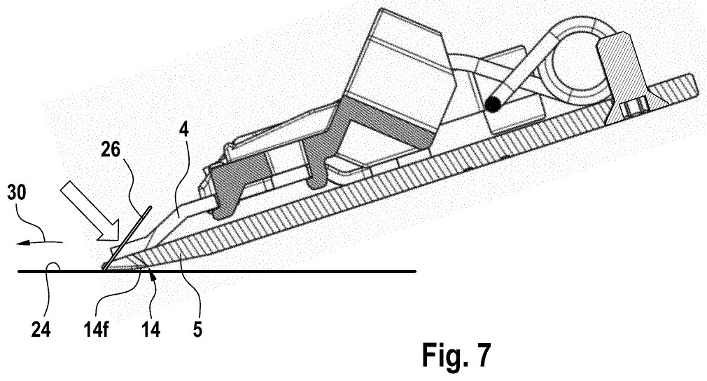

As can be seen from FIGS. 5, 6, 15 and 16, a forward end portion 14f of said skin contact surface 14 at the forward end portion of the cutter blade 5, may be inclined at an acute angle tri of, for example, 5° to 10° to a bottom surface portion positioned further rearwardly and/or to the cutting surface 8 between the cutter blades 4, 5 so that the skin contact surface 14 at the forward end portion of the cutter system 3 may have stable contact to the skin surface 24 when the cutter system 3 is tilted forwardly relative to the skin surface 24 so that the forward end portion of the cutter system 3 is tilted downwardly towards the skin surface 24, cf. FIG. 6. Such tilted position of the trimmer 1, cf. FIGS. 6 and 7, is a natural use of the trimmer 1 by users maneuvering the trimmer 1 along the skin surface 24 in the advancing direction 30, cf. FIG. 4, to get the comb-like cutting teeth 6, 7 close to the skin surface 24 and/or into the hairs to be cut to achieve a close cut.

FIGS. 5 to 8 and 16 show the skin contact surface 14 can be formed by the bottom side of the stationary cutter blade 5 itself. However, as mentioned before, said skin contact surface 14 also may be formed by the bottom side of a distance comb 15 which may be attached to the bottom side of the stationary blade 5, cf. FIG. 15. Also such skin contact surface 14 formed by such distance comb 15 may have an inclined forward end portion 14f inclined at said acute angle tri to the cutting plane 8.

As can be seen from FIG. 15, said inclined forward end portion 14f of the skin contact surface 14 does not need to be—but nevertheless may be—exactly planar, but may have a more or less slightly curved contour such as a convex, for example slightly barrel-shaped or approximately cylindrical rounding towards the forward end to help the cutter system in smoothly sliding along the skin. When the inclined forward end portion of the skin contact surface 14 has a curved configuration, a tangential plane 33 thereto, cf. FIG. 15, may be considered for the definition of the virtual plane 27 as will be described later.

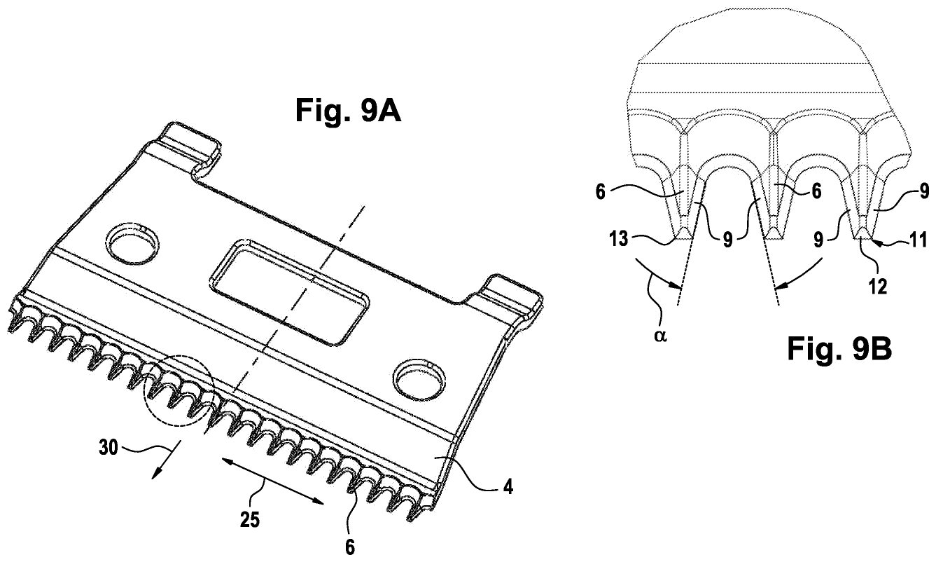

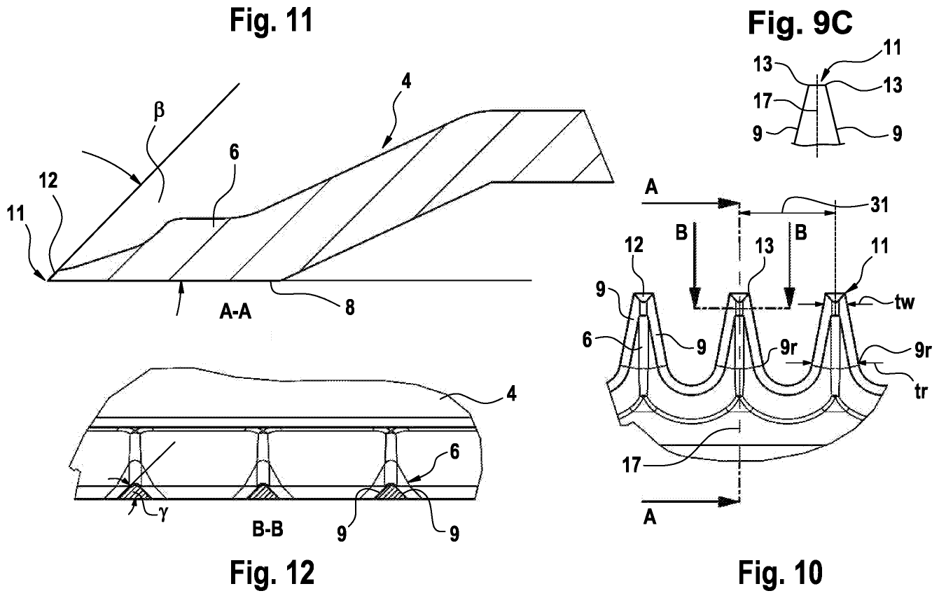

As can be seen from FIGS. 9 to 12, the cutting teeth 6, 7 of the movable cutter blade 4 each include pairs of lateral cutting edges 9 tapering towards a tooth tip 11, wherein the cutting teeth 6 may have a longitudinal tooth axis 17 extending substantially perpendicular to the reciprocating drive movement of the cutter blades 4, 5 relative to each other as it is indicated by double-arrow 25, cf. FIG. 9a.

The lateral cutting edges 9 of the cutting teeth 6 may extend substantially parallel to the cutting surface 8 which is defined between the cutter blades 4, 5. Such cutting surface 8 may be a cutting plane, wherein in such case the lateral cutting edges 9 may have a straight configuration. However, the cutting surface 8 also may have a non-planar, e.g. shovel-like configuration, wherein in such case the lateral cutting edges have a curved configuration. The non-planar, shovel-like configuration may have curvature in a plane perpendicular to the reciprocating drive movements and may have a linear or straight configuration in directions parallel to said reciprocating or cutting direction 25.

As can be seen from FIG. 9b, the lateral cutting edges 9 of neighboring cutting teeth 6 facing each other, may define an opening angle α indicative of the sort of V-shaped configuration of the gaps between neighboring cutting teeth 6. The width of such gap between neighboring teeth 6 basically increases from a bottom or route portion of the teeth 6 towards the tooth tips 11. In other words, the gaps become smaller when entering into the gaps deeper, cf. FIG. 9b.

Said opening angle α, cf. FIG. 9b, may range from 10° to 30° or from 20° to 25°. For example, an opening angle of 22° may be advantageous in terms of achieving a smooth cut with relatively small cutting forces on the hand and avoiding pushing hairs outwardly, as described earlier.

As can be seen from FIG. 12, the lateral cutting edges 9 may have a wedge-shaped configuration with a wedge angle γ, when considering a cross-sectional view of the cutting teeth 6 in a plane perpendicular to the longitudinal tooth axis 17, as it is indicated by line B-B in FIGS. 10 and 12. Said wedge angle γ may range from 35° to 60° or 40° to 55° or 45° to 50°, wherein, for example, a wedge angle of 48° may provide for an advantageous cutting action.

Basically, the smaller the wedge angle γ is, the easier is it for the cutter blade to penetrate the hair, wherein the likelihood that the hair will be cut immediately instead of being pushed out is significantly increased. A small wedge angle γ of the lateral cutting edge 9 also has the advantage of reducing cutting forces in terms of reducing the force acting on the teeth during cutting. Such reduced cutting forces allow the tooth tips 11 to be small without sacrificing the necessary stability. In other words, the tooth tips may become slimmer preventing the hairs from being pushed away by the tooth tips.

As can be seen from FIG. 9b and FIG. 11, the tooth tips 11 of the cutting teeth 6 of the movable cutter blade 4 may be provided with a basically flat, beveled tip surface 12 with a tip angle β defined between said flat beveled tip surface 12 and the cutting surface 8 and/or between the tip surface 12 and the longitudinal tooth axis 17, cf. FIG. 11, said tip angle β ranging from 40° to 80° or 40° to 70° or 50° to 70° or 45° to 65°. For example, the tip angle β may be about 60° so as to avoid hairs being pushed back, but nevertheless provide for the necessary stability.

More particularly, said beveled, flattened tip surface 12 of the movable blade 4 may be inclined relative to the aforementioned virtual plane 27 extending parallel to the cutting direction 25 of the movable cutter blade 4 and perpendicular to the inclined forward end portion 14f of the skin contact surface 14 at the bottom of the cutter system, cf. FIG. 15 and FIG. 16. As mentioned before, said inclined forward end portion 14f of the skin contact surface 14 may have a slightly convex or otherwise curved surface configuration, i.e. may have a non-planar configuration. In such non-planar case, a tangential plane 33 tangential to the inclined forward end portion of the skin contact surface 14 may be considered, cf. FIG. 15, wherein said virtual plane 27 may extend perpendicular to such tangential plane. More generally, the inclined forward end portion 14f of the skin contact surface 14 is basically the portion of the skin contact surface 14 under the tooth tips 11 and/or extending in the region of said tooth tips 11 to be in contact with the skin when the cutter system is positioned in a forwardly tilted orientation onto the skin, as it is shown, for example, in FIGS. 6 and 7.

Relative to said virtual plane 27, the tip surface 12 is inclined, at an acute angle £, backwardly towards the rear portion of the cutting teeth so the tooth tips 11 touch said virtual plan 27 only at the cutting surface 8, whereas the more elevated portions of the tip surface 12 is based apart and inclined away from said virtual plane 27 to form a substantially wedge-like void 29 between the virtual plane 27 and the tip surface 12, cf. FIG. 15 and FIG. 16.

Said acute angle c of inclination of the flattened, beveled tip surface 12 to the virtual plane 27 may range from 10° to 30° or 10° to 20°, cf. FIGS. 15 and 16. Said angle c also may be smaller than 10°, e.g. 3° or more or 5° or more.

Such range of the acute angle ε may be particularly advantageous for inclination angles φ of the inclined forward end portion 14 of the skin contact surface 14 to the cutting surface 8 ranging from 5° to 25° or from 10° to 20°, but also may be provided for other ranges of said inclination angle φ. Said inclination angle φ allows to reduce the thickness of the teeth towards the tooth tips what allows closer cutting action.

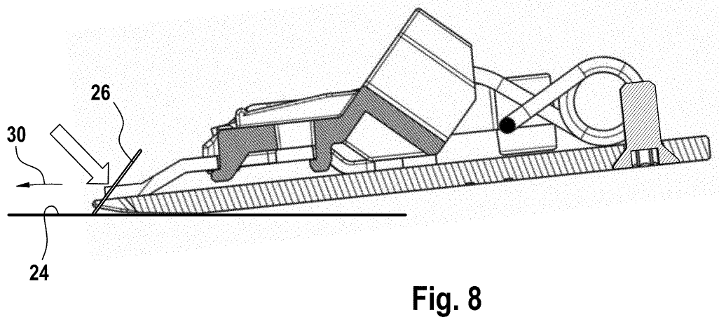

As can be seen from FIG. 6, a hair 26, even when growing out of the skin at an acute angle and, thus, inclined towards the cutter system 3, may not touch the reciprocating tooth tip 11. Typically, oblique hairs may grow out of the skin at an acute angle of e.g. about 40° so when advancing the cutter system 3 against the inclined hairs 26, as indicated by FIG. 6, there would be a likelihood of collision of the hairs 26 with the tooth tips 11, as it is indicated by FIGS. 7 and 8 showing cutter systems with cutting teeth having unbeveled tooth tips. A collision with such unbeveled tooth tips is not only likely to occur when the cutter system 3 is tilted forwardly as indicated by FIG. 7, to get the skin contact surface 14 fully onto the skin surface, but also when the cutter system 3 is used in a less steep position, as it is indicated by FIG. 8.

Consequently, pushing hairs out of the engagement zone of the lateral cutting edges 9 is significantly less likely to occur when the tooth tips 11 are provided with the aforementioned flat, beveled tooth tip surfaces 12 as shown by FIG. 6.

As shown by FIG. 15, the beveled flat tip surfaces 12 do not only help in avoiding pushing away the hairs when the cutter system 3, with its stationary cutter blade 5, is directly positioned onto the skin surface 24, but also when a so-called distance comb 15 is used. Such distance combs 15 are known per se and are used to adjust the cut length of the hair. More particularly, when a beard of a certain or increased length is desired, a distance comb 15 may be attached onto the bottom side of the cutter system 3 so that the cooperating cutting teeth 6, 7 are held at a certain distance away from the skin surface, cf. FIG. 15.

Said distance comb 15 also may define the skin contact surface 14 of the cutter system 3 with a forward end portion 14f positioned at a forward end portion of the cutter system 3, when considering an advancing direction 30 thereof, and/or basically at the cooperating rows of cutting teeth 6, 7, wherein the skin contact surface 14 and/or the forward end portion 14f thereof defined by the distance comb 15 may basically have an orientation and/or inclination parallel to the skin contact surface 14 and the forward end portion 14f thereof defined by the bottom side of the stationary cutter blade 5.

When considering said skin contact surface 14 defined by the bottom side of the stationary cutter blade 5 or defined by the distance comb 15, the tip surface 12 of the cutting teeth 6 of the movable cutter blade 4 may be inclined at an angle δ to the forward end portion 14f of the skin contact surface 14, cf. FIG. 15, wherein said angle δ may range from 60° to 85° or 75° to 85° in order to reliably avoid pushing away hairs entering into the gaps between neighboring teeth 6.

As can be seen from FIG. 13, the tip angle β and, correspondingly, the aforementioned angle δ to the skin contact surface 14 also may be chosen to be within the aforementioned ranges when the tip surface 12 is not exactly planar, but uneven in a relief-like manner Such uneven, relief-like shape of the tip surface 12 may be due to the manufacturing process and/or may be chosen on purpose. For example, the tip surface 12 have a concave configuration, cf. the right side of FIG. 13. More generally, the unevenness may be geometrically regular or may have an unregular, cloud-like configuration, cf. the left side of FIG. 13.

When the tip surface 12 shows some unevenness, the aforementioned angle c of inclination of the tip surface 12 to the virtual plane 27 may be defined between said virtual plane 27 and a plane 32 tangential to said tip surface 12, cf. FIG. 13. The same tangential plane 32 may be used to define the aforementioned angle β when the tip surface 12 is not planar.

With regard to the aforementioned wedge angle γ of the lateral cutting edges 9, cf. FIG. 12, it also should be noted that only a portion of the entire flank or side of the cutting teeth 6 may be adapted to said wedge angle γ. More particularly, only the edge portion forming the cutting edge 9 facing the cooperating tooth of the cooperating cutter blade 5 and/or the outer most edge portion immediately adjacent to the cutting surface 8 may define the aforementioned wedge angle γ, whereas on the other hand the flank portion of the tooth 6 further away from the cutting surface 8 and/or further away from the cutting edge 9 may have a steeper configuration, cf. FIG. 14. So as to achieve a sharp cutting edge and a smooth cutting action with low cutting forces, it is sufficient when the outer most edge portion of the lateral cutting edge 9 is configured to have the aforementioned wedge angle γ.

As can be seen from FIGS. 9b, 9c and FIG. 10, said flattened, beveled tip surface 12 may be substantially planar with an angular, ridge-like transition 13 to each of said lateral cutting edges 9, wherein said angular transition 13 may have a radius of curvature of less than 50 μm or less than 25 μm or less than 10 μm.

As can be seen from FIG. 10, the tooth tips 11 define a pyramid-like contour with three inclined, planar surfaces joining each other, wherein one of said inclined planar surfaces is formed by the flattened, beveled tip surface 12 and the other two inclined planar surfaces are formed by the lateral cutting edges 9 of the cutting tooth joining said tip surface 12. Said tooth tip contour is of course no exact, complete pyramid as it has only three flattened, inclined surfaces and lacks the fourth side of a pyramid and furthermore, it does not have a rectangular basis, but nevertheless it is sort of similar to a part of a pyramid having three flattened side surfaces inclined relative to each other and inclined relative to the basis.

Said flattened beveled tip surface 12 may define a tip width tw ranging from 150 μm to 400 μm or 200 μm to 300 μm, cf. FIG. 10.

When considering a rear end 9r of the cutting edges 9, said cutting edges 9 may have a substantially linear straight shape tapering towards the tooth tip. The width tw of the teeth 6 at the tooth tip 11 may range from ⅙ to ⅔ or ⅙ to ⅓ of a rear width tr of the cutting tooth 6 at the rear end 9r of the lateral cutting edge 9, cf. FIG. 10.

Said tip width tw may be adjusted to a pitch 31 of the toothing of the blades, wherein such pitch 31 is the distance from a center of a tooth to the center of a neighboring tooth, cf. FIG. 10. Considering such pitch 31, the tip width tw may range from 1/9 to ⅓ or ⅙ to ¼ of the pitch 31.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. Cutter system for an electric shaver and/or trimmer, comprising a pair of cooperating cutter blades each having at least one row of comb-like cutting teeth, wherein one of said cutter blades is a stationary cutter blade and the other one of said cutter blades is a movable cutter blade movable relative to said stationary cutter blade in a cutting direction along a cutting surface defined between said cooperating cutter blades, said cutting teeth each having pairs of lateral cutting edges tapering towards a tooth tip, wherein the tooth tips of at least the movable cutter blade are provided with a flattened, beveled tip surface, and wherein a skin contact surface of the cutter system has an inclined forward end portion for guiding the cutter blades in the region of said tooth tips over the skin of a user and defining an acute angle to said cutting surface, said skin contact surface being defined by a surface of said stationary cutter blade facing away from said movable cutter blade or by a distance comb attached to said stationary cutter blade, characterized in that said flattened, beveled tip surface is inclined to a virtual plane at an acute angle, said virtual plane extending parallel to said cutting direction and perpendicular to said skin contact surface and/or a tangential plane tangential thereto, so the tooth tip touches said virtual plane only at the cutting surface with a substantially wedge-shaped void between the flattened beveled tip surface and said virtual plane.

2. Cutter system according to claim 1, wherein said acute angle of inclination of the flattened beveled tip surface to the virtual plane ranges from about 10° to about 40° or about 10° to about 20°.

3. Cutter system according to claim 1, wherein said tooth tips of the movable cutter blade, in cross-sectional planes parallel to the cutting surface, define linear contours parallel to the cutting direction.

4. Cutter system according to claim 1, wherein the cutting teeth of the movable cutter blade, at the tooth tips, define a pyramid-like contour with three inclined, planar surfaces joining each other, one of said inclined, planar surfaces being formed by the flattened, beveled tip surface and the other two inclined, planar surfaces being formed by the lateral cutting edges of the cutting tooth.

5. Cutter system according to claim 1, wherein said flattened, beveled tip surface is substantially planar with an angular transition to each of said lateral cutting edges, said angular transition having a radius of curvature of less than about 50 μm or less than about 25 μm or less than about 10 μm.

6. Cutter system according to claim 1, wherein said cutting teeth have a tip width ranging from about ⅙ to about ⅔ or about ⅙ to about ⅓ of a rear width of the cutting teeth at a rear end of the lateral cutting edges which extend from said rear end to the tooth tip along a straight line.

7. Cutter system according to claim 1, wherein said cutting teeth have a tip width ranging from about 1/9 to about ⅓ or about ⅙ to about ¼ of a toothing pitch which is the distance from a center of a tooth to the center of a next tooth.

8. Cutter system according to claim 1, wherein said acute angle of the inclined forward end portion of the skin contact surface to the cutting surface ranges from about 5° to about 25° or from about 10° to about 20° and said acute angle of the flattened beveled tip surface to the virtual plane ranges from about 10° to about 30° or about 10° to about 20°.

9. Cutter system according to claim 1, wherein a tip angle between the flattened, beveled tip surface and the cutting surface ranges from about 30° to about 70° or about 50° to about 65°.

10. Cutter system according to claim 1, wherein said flattened beveled tip surfaces of the cutting teeth of the movable cutter blade are inclined to the forward end portion of the skin contact surface at an angle ranging from about 50° to about 85° or about 65° to about 85° or about 75° to about 85°.

11. Cutter system according to claim 1, wherein said flattened beveled tip surface defines a maximum tip width ranging from about 150 μm to about 400 μm or about 200 μm to about 300 μm.

12. Cutter system according to claim 1, wherein said lateral cutting edges, when considering a cross sectional view transverse to a longitudinal tooth axis of the respective cutting tooth, have a wedge-shaped configuration with a wedge angle ranging from about 35° to about 60° or about 40° to about 55° or about 45° to about 50°.

13. Cutter system according to claim 1, wherein a sum of the tip angle and the wedge angle is less than about 120° or less than about 110°, and/or ranges from about 90° to about 120° or from about 100° to about 110°.

14. Cutter system according to claim 1, wherein an opening angle defined by pairs of cutting edges of neighboring cutting teeth facing each other, ranges from about 10° to about 30° or about 15° to about 25° or about 20° to about 25°.

15. Cutter system according to claim 1, wherein a sum of the wedge angle and the opening angle is less than about 80° or less than about 75°, and/or ranges from about 60° to about 80° or about 65° to about 75°.

16. Cutter system according to claim 1, wherein a sum of the tip angle and the wedge angle and the opening angle is less than about 150° or less than about 140°, and/or ranges from about 110° to about 150° or about 120° to about 140°.

17. Electric shaver and/or trimmer, comprising a cutter system which is configured in accordance with claim 1.

18. Cutter system for an electric shaver and/or trimmer, comprising a pair of cooperating cutter blades each having at least one row of comb-like cutting teeth, wherein one of said cutter blades is a stationary cutter blade and the other one of said cutter blades is a movable cutter blade movable relative to said stationary cutter blade in a cutting direction along a cutting surface defined between said cooperating cutter blades, said cutting teeth each having pairs of lateral cutting edges tapering towards a tooth tip, wherein the tooth tips of at least the movable cutter blade are provided with a flattened, beveled tip surface.

19. Cutter system for an electric shaver and/or trimmer, comprising a pair of cooperating cutter blades each having at least one row of comb-like cutting teeth, wherein one of said cutter blades is a stationary cutter blade and the other one of said cutter blades is a movable cutter blade movable relative to said stationary cutter blade in a cutting direction along a cutting surface defined between said cooperating cutter blades, said cutting teeth each having pairs of lateral cutting edges tapering towards a tooth tip, wherein the tooth tips of at least the movable cutter blade are provided with a flattened, beveled tip surface wherein the flattened, beveled tip surface extends to the cutting surface of the cutting teeth with a tip angle (β) between the flattened, beveled tip surface and the cutting surface ranging from 30° to 70° or 50° to 65°, wherein said lateral cutting edges, when considering a cross sectional view transverse to a longitudinal tooth axis of the respective cutting tooth, have a wedge-shaped configuration with a wedge angle (γ) ranging from 35° to 60° or 40° to 55° or 45° to 50° and wherein a sum of the tip angle (β) and the wedge angle (γ) is less than 120° or less than 110°, and/or ranges from 90° to 120° or from 100° to 110°.

20. Cutter system according to claim 19, further comprising the features of at least any one of the following:
a) wherein said tooth tips of the movable cutter blade, in cross-sectional planes parallel to the cutting surface, define linear contours parallel to the cutting direction and/or,
b) wherein the cutting teeth of the movable cutter blade, at the tooth tips, define a pyramid-like contour with three inclined, planar surfaces joining each other, one of said inclined, planar surfaces being formed by the flattened, beveled tip surface and the other two inclined, planar surfaces being formed by the lateral cutting edges of the cutting tooth and/or,
c) wherein said flattened, beveled tip surface is substantially planar with an angular transition to each of said lateral cutting edges, said angular transition having a radius of curvature of less than 50 μm or less than 25 μm or less than 10 μm and/or,
d) Cutter system according to anyone of the preceding claims, wherein said cutting teeth have a tip width (tw) ranging from ⅙ to ⅔ or ⅙ to ⅓ of a rear width (tr) of the cutting teeth at a rear end of the lateral cutting edges which extend from said rear end to the tooth tip along a straight line and/or,
e) Cutter system according to anyone of the preceding claims, wherein said cutting teeth have a tip width (tw) ranging from 1/9 to ⅓ or ⅙ to ¼ of a toothing pitch which is the distance from a center of a tooth to the center of a next tooth and/or,
f) wherein said flattened beveled tip surfaces of the cutting teeth of the movable cutter blade are inclined to the forward end portion of the skin contact surface at an angle (δ) ranging from 50° to 85° or 65° to 85° or 75° to 85° and/or,
g) wherein said flattened beveled tip surface defines a maximum tip width ranging from 150 μm to 400 μm or 200 μm to 300 μm and/or,
h) wherein an opening angle (α) defined by pairs of cutting edges of neighboring cutting teeth facing each other, ranges from 10° to 30° or 15° to 25° or 20° to 25° and/or,
i) wherein a sum of the wedge angle (γ) and the opening angle (α) is less than 80° or less than 75°, and/or ranges from 60° to 80° or 65° to 75° and/or,
j) wherein a sum of the tip angle (β) and the wedge angle (γ) and the opening angle (α) is less than 150° or less than 140°, and/or ranges from 110° to 150° or 120° to 140° and/or,
k) wherein said cutter system is part of an electric shaver and/or trimmer and is optionally configured in accordance with one of the preceding claims.
